(19) United States
(12) Patent Application Publication
(10) Pub. No.: US 2017/0171934 A1
(43) Pub. Date: Jun. 15, 2017

(54) SLOW ILLUMINATING AND CUSTOMIZABLE LIGHT SYSTEM

(71) Applicants: Charles Cunningham, Granbury, TX (US); Dennis Carnine, Tonganoxie, KS (US)

(72) Inventors: Charles Cunningham, Granbury, TX (US); Dennis Carnine, Tonganoxie, KS (US)

(21) Appl. No.: 15/376,791

(22) Filed: Dec. 13, 2016

Related U.S. Application Data
(60) Provisional application No. 62/267,021, filed on Dec. 14, 2015.

(51) Int. Cl. H05B 33/08; H05B 37/02

(52) U.S. Cl. CPC H05B 33/0857; H05B 37/0281; H05B 37/0227; H05B 33/0854; F21S 9/03

(57) ABSTRACT

The present invention relates generally to the fields of outdoor lighting and more particularly to a flexible, slow illuminating light.

### CROSS-REFERENCE TO RELATED APPLICATIONS

This application claims priority to U.S. Provisional Patent Application No. 62/267,021 filed Dec. 14, 2015 entitled “Slow Illuminating And Customizable Light System”, the contents of which are expressly incorporated herein by reference.

### STATEMENT REGARDING FEDERALLY FUNDED RESEARCH

None.

### BACKGROUND

I. Field of the Invention

The present invention relates generally to the fields of outdoor lighting and more particularly to a flexible, slow illuminating light.

II. Description of Related Art

Many external lighting systems may be activated by movement and frequently illuminate immediately upon activation. Moreover, the light is generally bright, white light so as to be readily visible to humans. This facilitates observation and also serves as a deterrent to intruders.

### SUMMARY

The present disclosure is directed to an illumination system comprising a housing, at least one illumination arm affixed to said housing, wherein the illumination arms are flexible and wherein the distal end of each illumination arm comprises an illumination head, the illumination head comprising at least two bulbs of different colors and a driver system capable of controlling the rate of current to said bulbs.

In addition, the illumination heads of the system further comprise a motion sensor within said head.

It is contemplated that any embodiment of a method or composition described herein can be implemented with respect to any other method or composition described herein.

The use of the word “a” or “an” when used in conjunction with the term “comprising” in the claims and/or the specification may mean “one,” but it is also consistent with the meaning of “one or more,” “at least one,” and “one or more than one.”

The use of the term “or” in the claims is used to mean “and/or” unless explicitly indicated to refer to alternatives only or the alternative are mutually exclusive, although the disclosure supports a definition that refers to only alternatives and “and/or.”

Throughout this application, the term “about” is used to indicate that a value includes the standard deviation of error for the device or method being employed to determine the value.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### DESCRIPTION OF THE DRAWINGS

The following drawings form part of the present specification and are included to further demonstrate certain aspects of the present invention. The invention may be better understood by reference to one or more of these drawings in combination with the detailed description of the specification embodiments presented herein.

FIG. 1 is an image showing features of the system outlined in the present disclosure.

FIG. 2 is an image showing exemplary placement of multiple different colored bulbs in an illumination head.

FIG. 3 is an image showing illumination heads capable of independent movement as outlined herein.

### DESCRIPTION

While current methods of illumination are effective, there exists a need in the art for improved illumination systems that provide flexibility, light interchangeability and control over the rate of illumination. Accordingly, the present disclosure provides an illumination system in which multiple attributes are controlled by a user or factory setting. As described herein, these attributes include but are not limited to direction of illumination color of illumination and rate of illumination Such illumination systems find multiple uses, for instance, in security, wildlife surveillance and/or hunting.

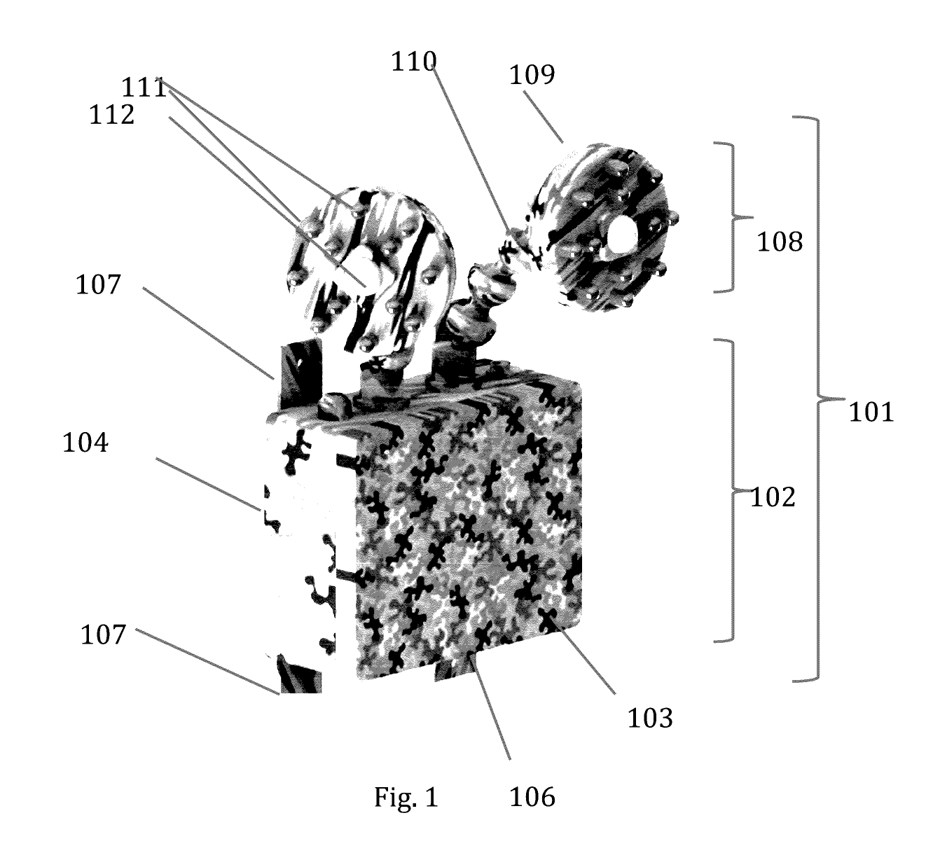

Turning to FIG. 1, an illumination system 101 of the present disclosure provides a housing unit 102 comprising a lid 103 affixed to a base 104. The lid 103 and base 104 may be affixed by any of a variety of known methods including at least one, two, three or more hinges or may be affixed with screws. The lid may be closably sealed to the base by one or more latches or 1, 2, 3, 4 or more screws 106 as is known in the art. The latch may comprise one or more locks, including a keyed lock, combination lock and the like. Batteries and other electrical controls including the microprocessor may be found within the housing.

The housing may also be affixed to mounting pieces 107. These provide for mounting the unit to a post, tree, house or other desired location.

Also attached to the housing is at least one flexible light element 108. The flexible light element is comprised of a flexible arm that can be bent in any desirable direction. To the distal end of the flexible arm is affixed a lighting head unit 109. In some embodiments the lighting head unit is rotationally affixed to the flexible arm 110 by any of a variety of methods, such as a ball and socket joint, such as, but not limited to a Loc Line adapter In one embodiment the lighting head unit contains the electronic controls such as a microprocessor, capable of regulating the intensity and rate of illumination of the lights in the head unit. That is the microprocessor circuit allows the light to slowly brighten after the motion is detected. The microprocessor circuit also helps control the balance to the drivers since the different colored lights operate on different currents. In an alternative embodiment, the microprocessor may be in the battery box along with other electronics. There can be 2 drivers, (one for each color) in each head, along with 12 LEDs (6 of each color). The light uses a battery, which may be a 12-volt battery that is optionally charged by a solar panel.

In some embodiments the system includes an on/off switch, a solar panel jack and connectors, such as but not limited to Amphenol connectors. Preferably the system includes an electronics master board comprising a microprocessor configured to control the rate of illumination, balance of the LEDs and the time the light stays active after motion ceases and a battery. The system also includes at least one illumination arm affixed to said housing, wherein said illumination arm is flexible and wherein the distal end of each illumination arm comprises an illumination head. The illumination head comprises at least two bulbs of different color and a driver system, such as but not limited to a pulse width modulation (PWM) driver system, capable of controlling the current to said bulbs. The driver system is configured to regulate the length of time the light is illuminated. The drivers used for each color are, for instance, PWM drivers and the microprocessor controls how long each cycle is. This allows for a situation in which the LED illuminates at maximum brightness or less than maximum brightness to use less power. The PWM allows for control where the “on time” is at the brightest without wasting energy.

In one embodiment the lighting head unit also comprises at least two discrete bulbs 111.

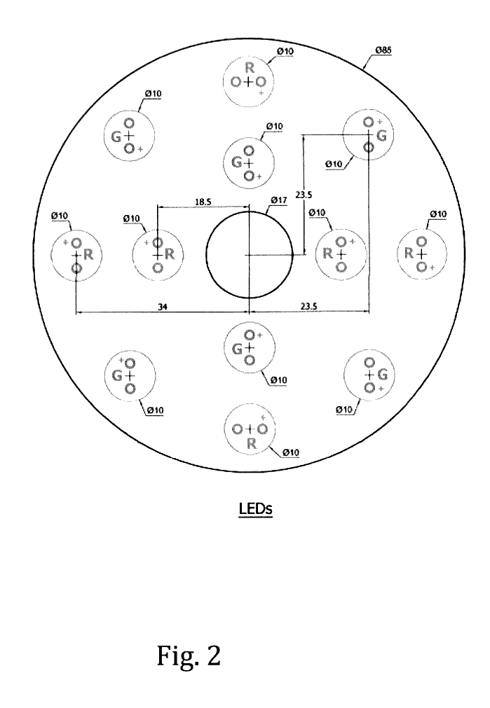

In general it is preferable for each lighting head to contain at least 3, 4, 5, 6, 7, 8, 9 or more, such as up to 10, up to 20, up to 30, up to 40 bulbs. In some embodiments these bulbs are of a single color, while in some embodiment the bulbs are of at least a first and second different color, such as red and green bulbs. For instance in one non-limiting embodiment 6 red and 6 green bulbs are used. See FIG. 2. Any number of any color bulbs may find use in the system. Notably, in some embodiment the bulbs are replaceable and can be interchanged with different colored bulbs as desired.

Benefits of using lights of different colors include the use of bright, white bulbs in security lights, and the use of red/green lights for hunting as certain game are unable to detect or only modestly detect the non-white light. In particular it is noted that feral hogs, which represent a significant and growing problem for farmers, ranchers and the like, do not see the color orange or do not see it well. As such, rather than illuminate with white light and startle the game, illumination is accomplished with red/green lights such that the game is not startled. In addition, other bulbs, such as UV or bulbs emitting different wavelengths find use in the illumination system described herein. In some embodiments using bulbs of different colors and wattage specific colors of illumination can be achieved. For instance using a 1 watt red bulb and a 0.5 watt green bulb results in an orange light, a color not detectable by certain game species, such as feral hogs, in some embodiments, the lights, which may be LED lights, are powered by Pulse Width Modulated LED drivers to conserve the battery power. Red lights are outside of many animals' detectable visible wavelength. They also are not necessarily bright enough for the human eye to perceptibly see. Green lights are much more perceptibly bright to the human eye, but green is barely in the visible spectrum of the animals. By using this red/green color combination, and by properly balancing the perceptible brightness of the 2 colors, (i.e. dimming the green and brightening the red), a bright orange light can be achieved and still stay outside of the visible wavelength of some animal such as hogs.

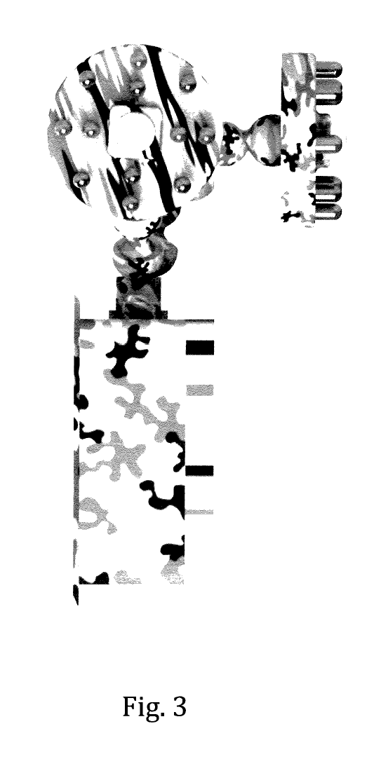

Also included in the lighting head is a motion sensor 112. Motion sensors are known in the art. However, in the illumination system described herein the motion sensor is found in the flexible lighting unit. This allows for customizable, independently designed monitoring for motion based on a single fixed location of the illumination housing. That is, generally motion sensors are affixed to the housing unit and therefore are capable of monitoring only activity in the direction the housing unit is facing. While these detectors are capable of detecting movement within a particular field of detection of about 160 degrees in one direction, the present illumination system has customizable and independently configurable motion sensors. That is, each illumination arm can be independently moved to a particular direction and optionally independently illuminated. In some embodiments upon activation of a motion detector all heads may illuminate. Alternatively, in some embodiments, the heads are independently regulated by the respective motion detector. See FIG. 3. Thus, when two lights are pointed 180 degrees apart, each may have a range of detection of potentially 160 degrees each. Using two independent illumination arms, therefore doubles the range of detection. Likewise, adding a third, fourth light or more, increases the range of detection such that a 360-degree coverage is possible. That is, the infinitely adjustable heads allow the user to point the light or lights where it/they will be most effective.

In some embodiments the motion sensors are activated when a certain level of darkness is reached and inactivated when a certain level of light is reached. In some embodiments, when motion is detected, a microprocessor is activated and the microprocessor circuit slowly increases the current to the lights, e.g. LED drivers. These in turn power the lights which increasingly get brighter. The lights remain at this brightness until motion ceases. When the motion is no longer detected the light turns off after a certain factory set time.

The rate of illumination also may be independently controlled for each illumination head or in some embodiments it may be the same for each. In some embodiments maximum illumination occurs instantly upon activation of the motion sensor. However, in alternative embodiments illumination may take 2, 5, 10, 20, 30, 60, 90, 120, 150, 180, 210, 240, 270 or more seconds to reach maximum illumination. In this embodiment the illumination occurs over a period of from 1-4 minutes, more preferably from about 2-3 minutes.

In addition, illumination intensity may be customized within each illumination head. That is, in some instances, maximum illumination is desired. However, in some embodiments, less than maximum illumination is desired, such as 90%, 75%, 50%, 30%, or 10% of maximum illumination is needed or desired.

Illumination controls may be found in the housing unit, or in some embodiments may be found in each of the respective illumination heads. These controllers independently configurable with respect to rate of illumination, duration of illumination, sensitivity of the motion sensor.

The proximal end of the illumination arm is reversibly and flexibly attached to the housing. This allows for interchangeability of each independent arm. In some embodiments the connections is via a LocLine connection. In one embodiment the connections between the head and neck assembly and the housing unit is modular. That is, connections such as but not limited to locking plug, military connection or other type that allows the connections to make or facilitate electrical connections with the battery and programming wires, allowing the assemblies to be removed and/or replaced. Amphenol Connector As described herein, in one embodiment the electronics, including PCT, drivers, motion detector and bulbs (LEDs) are housed within each head. Thus, should one arm or illumination head need to be replaced this can be done without replacing the entire unit. This also provides for a system to which illumination heads/arms can be added or removed according to the desire and need of the user. As such, the housing units are configured to receive at least 2, 3, 4, 5, 6, 7, 8, 9 or 10 independent illumination arms.

Another optional feature of the illumination system is a reversible attachable solar panel.

The panel may be configured to charge the batteries found in housing as is known in the art. Other features of the system include an on/off switch and a solar panel jack. In some embodiments the system is UV resistant and may be optionally colored in camouflage print. In some embodiments the system is waterproof or water resistant.

Once made, the illumination system described herein is applicable to multiple uses. In one embodiment the illumination system finds use as a precisely configurable security system. In this embodiment, the mounted system can be configured to detect motion in multiple desired locations and the illumination independently controlled. In an alternative embodiment the illumination system finds use as a customizable hunting light. In this embodiment, the mounted or affixed system can be configured to detect movement in multiple, distinct or overlapping regions, the lighting color, rate of illumination and intensity can all be independently configured or are optionally factory set

While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the present invention.

1. A system comprising:
a. a housing comprising an electronics master board comprising a microprocessor configured to control the rate of illumination, balance of LED lights and the time the LED lights stay on; and
b. at least one illumination arm affixed to said housing, wherein said illumination arm is flexible and wherein the distal end of each illumination arm comprises an illumination head, said illumination head comprising:
i. at least two bulbs of different colors;
ii. a PWM driver system capable of controlling the current to said bulbs.

2. The system according to claim 1, wherein each of said illumination heads further comprises a motion sensor within said head.

3. The system according to claim 2, wherein said motion sensors are in substantially the center of said illumination heads.

4. The system according to claim 1, wherein each of said heads comprises at least 12 bulbs, wherein 6 are red and 6 are green.

5. The system according to claim 1, wherein said system further comprises a battery.

6. The system according to claim 1, wherein said bulbs are red and green.
